(19) United States
(12) Patent Application Publication
(10) Pub. No.: US 2020/0342847 A1
(43) Pub. Date: Oct. 29, 2020

(54) Elastic Sound Generating Device

(71) Applicant: BUMBLEBEE STUDIO LIMITED, Hong Kong (HK)

(72) Inventors: Ying Yew Gary MAN, Hong Kong (HK); Yuen Pik Pandora MAK, Hong Kong (HK)

(73) Assignee: BUMBLEBEE STUDIO LIMITED

(21) Appl. No.: 16/503,604

(22) Filed: Jul. 4, 2019

(30) Foreign Application Priority Data
Apr. 26, 2019 (CN) 201920582681.5

(51) Int. Cl. G10K 13/00; A63B 21/02; G10K 9/10

(52) U.S. Cl. CPC G10K 13/00; G10K 9/10; A63B 21/02

(57) ABSTRACT

An elastic sound generating device, comprising an elastic sounding body integrally formed of an elastic material, the elastic sounding body having therein one or more sound amplified holes which can be pressed to adhere and then released to generate vibration and sound, and the sound amplified hole is opened through an outer surface of the elastic sounding body. The elastic sounding body is pressed and deformed until inner walls of the sound amplified hole adhere to each other, and then the elastic sounding body is released to restore the original shape and separate the inners wall of the sound amplified hole, and when the inner walls of the sound amplified hole are separated from each other, a sound is generated. The generated sound as a detectable signal is a solution for the range of motion of the training joint, the strength of the output and the shortest duration.

### BACKGROUND OF INVENTION

### 1. Field of the Invention

The present invention relates to a technical field of sounding products, particularly to an elastic sound generating device.

### 2. Description of Related Art

Strength trainers, suspension structures, or other forms of equipment use elastic materials as the physical equipment under pressure. When the physical equipment is pressurized, it does not provide any detectable signals (sound and vibration). The physical equipment ultimately cannot meet the following standards:

1. Train the range of motion of the joint and the strength of the output.

2. Show the duration of the maximum stress.

In view of this, the inventor proposes the following technical solutions.

### SUMMARY OF THE INVENTION

The purpose of the present invention is to overcome the deficiencies of the prior art and to provide an elastic sounding device.

In order to solve the above technical problems, the present invention adopts the following technical solutions:

An elastic sound generating device, comprising an elastic sounding body integrally formed of an elastic material, the elastic sounding body having therein one or more sound amplified holes which can be pressed to adhere and then released to generate vibration and sound, and the sound amplified hole is opened through an outer surface of the elastic sounding body.

More preferably, wherein the elastic sounding body is pressed and deformed until inner walls of the sound amplified hole adhere to each other, and then the elastic sounding body is released to restore the original shape and separate the inners wall of the sound amplified hole, and when the inner walls of the sound amplified hole are separated from each other, a sound is generated.

More preferably, wherein the inner wall of the sound amplified hole is provided as a smooth surface.

More preferably, wherein the elastic material is made of thermoplastic elastomer (TPE).

More preferably, wherein the elastic sounding body is any one of a spherical shape, an elliptical shape, a circular shape and a tubular shape.

More preferably, wherein a bottom portion of the elastic sounding body has a flat surface along which the sound amplified hole is formed to an inside of the elastic sounding body.

After adopting the above technical solutions, the present invention has the following beneficial effects compared with the prior art:

the elastic sound generating device can apply pressure to the elastic sounding body by holding the elastic sounding body when in use. The applied pressure presses the elastic sounding body to be deformed until the inner wall of the sound amplified hole adheres to each other, since the elastic sounding body has elasticity, when the elastic sounding body is released, the elastic sounding body can be automatically restored by the elastic restoring force generated by being pressed, so that the inner walls adhered to each other in the sound amplified hole are separated, and when the inner walls of the sound amplified hole are separated from each other, a sound is generated, and an vibration is also generated during the automatic restoration process, the generated sound and vibration as a detectable signal is a solution for the range of motion of the training joint, the strength of the output and the shortest duration. In addition, the structure of the elastic sound generating device is extremely simple, the cost is extremely low, and the market competitiveness of the present invention can be further improved.

### BRIEF DESCRIPTION OF THE DRAWINGS

FIG. 1 is a front view of the present invention;

FIG. 2 is a bottom view of the present invention;

FIG. 3 is a front view of the present invention after being pressed;

FIG. 4 is a bottom plan view of the present invention after being pressed and deformed.

### DETAILED DESCRIPTION OF THE INVENTION

The present invention will be further described below in conjunction with the specific embodiments and the accompanying drawings.

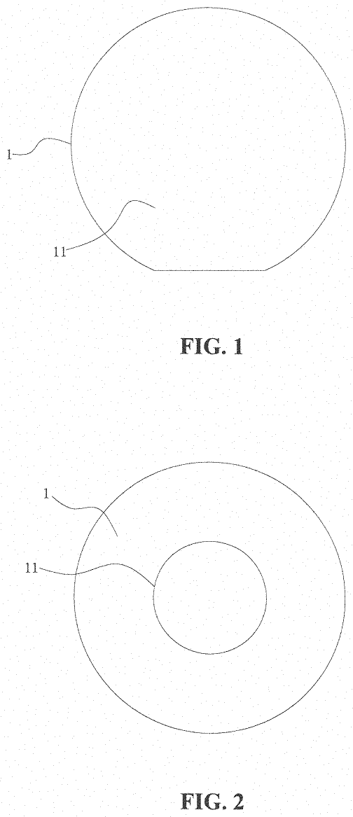

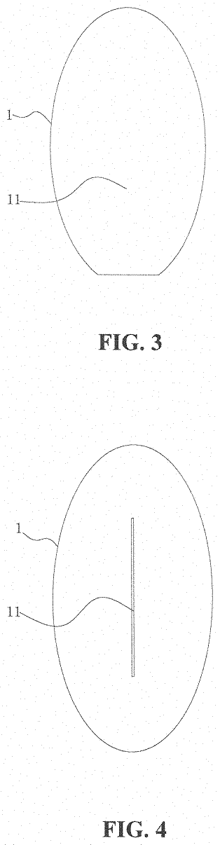

FIGS. 1-4 show an elastic sound generating device comprising an elastic sounding body 1 integrally formed of an elastic material, the elastic sounding body 1 has therein one or more sound amplified holes 11 which can be pressed to adhere and then released to generate vibration and sound, and the sound amplified hole 11 is opened through an outer surface of the elastic sounding body 1. When in use, the elastic sounding body 1 can be pressed by applying pressure, and the applied pressure presses the elastic sounding body 1 to be deformed until an inner wall of the sound amplified hole 11 adheres to each other, since the elastic sounding body 1 has elasticity, when the elastic sounding body 1 is released, the elastic sounding body 1 can be automatically restored by the elastic restoring force generated by being pressed, so that the inner walls adhered to each other in the sound amplified hole 11 are separated, and when the inner walls of the sound amplified hole 11 are separated from each other, a sound is generated, and an vibration is also generated during the automatic restoration process, and the generated sound and vibration are used as detectable signals to display the following indexes:

1. Train the strength of the joint motion range; it can show the range of motion of the finger joint and the intensity of the force applied.

2. Show the maximum duration of the pressure (the time it is held until it is released).

The inner wall of the sound amplified hole 11 is provided as a smooth surface so that a good adhesion effect can be achieved when the inner walls of the sound amplified hole 11 are adhered to each other.

The elastic material is made of thermoplastic elastomer (TPE), which has an elastic force that is quickly restored without being pressed. Of course, the elastic material may also be other elastic materials other than the TPE material, as long as it has elastic restoring force after being pressed.

The elastic sounding body 1 is any one of a spherical shape, an elliptical shape, a circular shape, and a tubular shape. Of course, other shapes may be used.

In this embodiment, as a preferred embodiment, the elastic sounding body 1 is spherical and has a diameter of 65 mm. The sound amplified hole 11 has a cylindrical shape with a depth of 50 mm and a diameter of 25 mm. The above dimensions have been measured and adjusted to achieve the best possible sound.

wherein a bottom portion of the elastic sounding body 1 has a flat surface along which the sound amplified hole 11 is formed to an inside of the elastic sounding body 1.

In summary, the elastic sound generating device can apply pressure to the elastic sounding body 1 by holding the elastic sounding body 1 when in use. The applied pressure presses the elastic sounding body 1 to be deformed until the inner wall of the sound amplified hole 11 adheres to each other, since the elastic sounding body 1 has elasticity, when the elastic sounding body 1 is released, the elastic sounding body 1 can be automatically restored by the elastic restoring force generated by being pressed, so that the inner walls adhered to each other in the sound amplified hole 11 are separated, and when the inner walls of the sound amplified hole 11 are separated from each other, a sound is generated, and an vibration is also generated during the automatic restoration process, the generated sound and vibration as a detectable signal is a solution for the range of motion of the training joint, the strength of the output and the shortest duration. In addition, the structure of the elastic sound generating device is extremely simple, the cost is extremely low, and the market competitiveness of the present invention can be further improved.

The above only describes some exemplary embodiments of the present invention. Those having ordinary skills in the art may also make many modifications and improvements without departing from the conception of the invention, which shall all fall within the protection scope of the invention.

I claim:

1. An elastic sound generating device, comprising
an elastic sounding body (1) integrally formed of an elastic material, the elastic sounding body (1) having therein one or more sound amplified holes (11) which can be pressed to adhere and then released to generate vibration and sound, and the sound amplified hole (11) is opened through an outer surface of the elastic sounding body (1).

2. The elastic sound generating device according to claim 1, wherein the elastic sounding body (1) is pressed and deformed until inner walls of the sound amplified hole (11) adhere to each other, and then the elastic sounding body (1) is released to restore the original shape and separate the inners wall of the sound amplified hole (11), and when the inner walls of the sound amplified hole (11) are separated from each other, a sound is generated.

3. The elastic sound generating device according to claim 2, wherein the inner wall of the sound amplified hole (11) is provided as a smooth surface.

4. The elastic sound generating device according to claim 3, wherein the elastic material is made of thermoplastic elastomer (TPE).

5. The elastic sound generating device according to claim 4, wherein the elastic sounding body (1) is any one of a spherical shape, an elliptical shape, a circular shape and a tubular shape.

6. The elastic sound generating device according to claim 3, wherein a bottom portion of the elastic sounding body (1) has a flat surface along which the sound amplified hole (11) is formed to an inside of the elastic sounding body (1).
